(19) United States
(12) Patent Application Publication
(10) Pub. No.: US 2012/0221991 A1
(43) Pub. Date: Aug. 30, 2012

(54) Interactive Method and Apparatus for Detecting Texted Metal Short Circuits

(75) Inventors: Pamela Liu, Mountain View, CA (US); Chia-Wei Wang, Taipei (TW); Sz-Cheng Huang, Taipei (TW); Jason Puryear, Cary, NC (US)

(73) Assignee: SYNOPSYS, INC., Mountain View, CA (US)

(21) Appl. No.: 13/504,439

(22) PCT Filed: Oct. 27, 2010
(86) PCT No.: PCT/IB2010/002740

§ 371 Date: Apr. 26, 2012

(30) Foreign Application Priority Data
Oct. 30, 2009 (CN) 200910209626.2
Oct. 30, 2009 (CN) 200910211375.1

(51) Int. Cl. G06F 17/50

(52) U.S. Cl. 716/112

(57) ABSTRACT

Methods and devices are disclosed herein to test the texted metal short circuit. One such method comprises: To input a circuit design file, wherein the circuit design file comprises the data of the layout pattern of the circuit design, the file format of the circuit design is a generic data stream format; to input a set of design rules; to select a specific check rule based on the set of design rules, wherein the specific check rule is for testing the texted metal short circuit in the circuit design; to execute a verification program [procedure] on the circuit design based on the specific check rule so as to obtain a first test result, wherein the first test result comprises all short circuit paths in the circuit design; and, based on the first rest result, to execute a pseudo-texted program using fuzzy algorithm so as to obtain a second test result.

### TECHNICAL FIELD

The present invention is related to a test method and device in circuit design, particularly to a method and device to test the texted metal short circuit in the circuit design.

### BACKGROUND

With continuous progress in the manufacturing technology of integrated circuits (IC), the minimum size of IC chips also keeps decreases. However, in the physical design with the tendency to reduce the chip size, it is more necessary to consider impact of manufacturability on the yield and reliability, while the problem of power loss in particular requires attention. A typical rule of treatment is to specify the ampere of the current borne by the wire [conductor] per unit width. On the other hand, limitation of the total power is also an important subject, and in terms of its extended problem of heat dissipation, for a single packaging design, it needs to have the capacity of heat dissipation before the device is damaged. A standard IC packaging is capable of dissipating a number of watts of heat. However, with the heat fin or other methods of heat dissipation, a novel packaging design has even better capacity of heat dissipation.

Physical design verification of an IC circuit is an important link in the flow process of circuit design. The step of physical design verification is one wherein whether an IC circuit is in conformity with all flow process rules will be confirmed. The geometric design rule is to check the relative position or syntax of the final layout of a circuit to ensure that said circuit can be manufactured correctly. However, the functional correctness test will be accomplished with the help of a simulator and verifier capable of maneuvering circuit action and behavior. For the electrical rule check or design rule check, it is for processing layout syntax and complicated behavior analysis. The electrical rule is a rule concerning the relevant attribute of a circuit, and it can be determined by the geometric and connecting relationship.

In the work of verification of an IC circuit design, testing of the position of the texted metal short circuit is an important subject. However, the test method using existing tools lists all polygons in a short circuit path, and then the user needs to check the listed polygons one by one. After said short circuit path check is completed, the verification tool is used again so as to get another short circuit path, and then the user once again checks the listed polygons one by one. The procedure is done repeatedly until the work of testing all short circuit positions is complete, thus costing too much time. Therefore, the industry of electronic design automation needs to have an efficient method and device to test the position of the texted metal short circuit, so as to reduce the time range for the design of the circuit.

### SUMMARY

Provided in the present invention are methods and devices to test a texted metal short circuit and for detecting character labeled metal short circuit positions; to execute a verification program on said circuit design based on said specific check rule so as to obtain a first test result, wherein said first test result comprises all short circuit paths in said circuit design; and then based on said first rest result, to execute a pseudo-texted program using a fuzzy algorithm so as to obtain a second test result. The user can confirms the metal short position in sequence in light of said first test result and said second test result respectively, so as to speed up testing of the position of the texted metal short circuit in said circuit design.

A method to test the texted metal short circuit as disclosed in an example of the present invention, which comprises the following steps: To input a circuit design file, wherein said circuit design file comprises the data of the layout pattern of said circuit design, and said circuit design file format is a generic data stream format; to input a set of design rules; to select a specific check rule based on said set of design rules, wherein said specific check rule is for testing the texted metal short circuit in said circuit design; to execute a verification program on said circuit design based on said specific check rule so as to obtain a first test result, wherein said first test result comprises all short circuit paths in said circuit design; and based on said first rest result, to execute a pseudo-texted program using a fuzzy algorithm so as to obtain a second test result. Said first test result is a cell short test result, or a hierarchical short test result, or it comprises a cell test result and a hierarchical short test result at the same time, but the present invention is not to be limited by that. Said first test result also comprises information of the position of the texted metal short circuit. The verification program mentioned above is a design rule check program. The pseudo-texted program as mentioned above is a VDD and VSS texted program, but the present invention is not to be limited by that.

A device to test the texted metal short circuit as disclosed in an example of the present invention, which comprises an input module, a selecting cell, an executing cell, a generating cell, a modifying cell, a confirming cell, an updating cell, and a display cell. Said input module is constructed to input a circuit design file and a set of design rules, wherein said circuit design file comprises data of the layout pattern, the file format of said circuit design is a generic data stream format, but the present invention is not to be limited by that. Said selecting cell is constructed to select a specific check rule based on said set of design rules. Said specific check rule is for testing at least one texted metal short circuit in said circuit design, but the present invention is not to be limited by that. Said executing cell is constructed to execute a verification program on said circuit design based on said specific check rule and to execute a pseudo-texted program using a fuzzy algorithm based on the result of said verification program. Said verification program is a design rule check program. Said pseudo-texted program is a VDD and VSS texted program, but the present invention is not to be limited by that. Said generating cell is constructed to generate a test result or a status to be confirmed, based on the result of said verification program or the result of said pseudo-texted program. Said test result is a cell short test result, or a hierarchical short test result, or it comprises a cell test result and a hierarchical short test result at the same time, but the present invention is not to be limited by that. Said test result also comprises information of the position of the texted metal short circuit. Said modifying cell is constructed to modify said circuit design based on said test result. Said confirming cell is constructed to obtain the information of confirmation of said status to be confirmed provided by a user. Said updating cell is constructed to update said test result or said status to be confirmed based on a modification result of said modifying cell. And said display cell is constructed to display said test result or said status to be confirmed.

The technical features of the present invention have already been summarized above, for better understanding of the following detailed description of the present invention. Other technical features that constitute the object of the claims of the present invention will be described below. Regular technical personnel in the technical field to which the present invention belongs should understand that the concept and specific examples disclosed below as a basis can be easily modified or used to design another structure or manufacturing process to accomplish the same purpose of the present invention. Regular technical personnel in the technical field to which the present invention belongs should also understand that this kind of equivalent constructs do not break away from the spirit and range of the present invention as suggested in the claims attached.

### BRIEF DESCRIPTION OF THE DRAWINGS

FIG. 1 is a flow chart of an example of the present invention of a method to test a texted metal short circuit;

FIG. 2 is a detailed step of Step 102;

FIG. 3 is a detailed step of Step 103;

FIG. 4 is a block view of another example of the present invention of a device to test a texted metal short circuit; and

FIG. 5 shows the unit short circuit position detecting window of an application example of the present invention.

### DETAILED DESCRIPTION OF DISCLOSED EMBODIMENTS

The direction of the present invention discussed here is a method and device to test a texted metal short circuit. For thorough understanding of the present invention, detailed steps and composition will be provided in the description below. It is obvious that the implementation of the present invention is not limited to the special details that technical personnel in circuit design are familiar with. On the other hand, the known composition or steps are not described in detail, to avoid unnecessary limitation of the present invention. A preferred example of the present invention will be described in detail below. However, besides these detailed descriptions, the present invention can also be extensively implemented in other examples, and the scope of the present invention is not limited, and is based on the claims above.

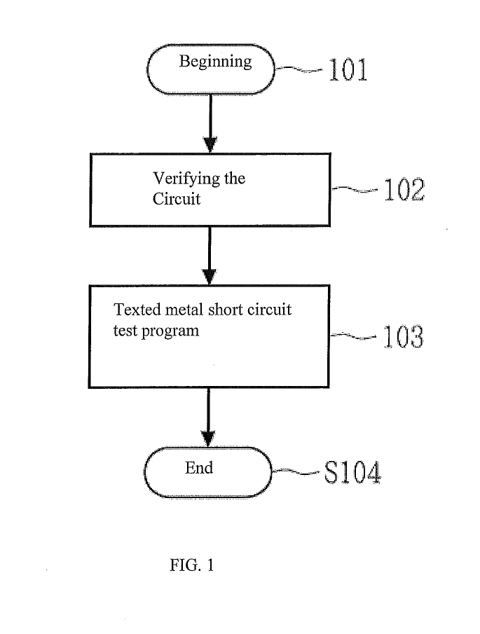

FIG. 1 is a flow chart showing an example of the present invention of a method to test a texted metal short circuit. In order that regular technical personnel in the present field can implement the present invention through the present example, the flow process of the method to test a texted metal short circuit is illustrated below in association with FIG. 1-3.

In Step 101, the flow process of the present example begins. In Step 102, a circuit input by a user to be tested is verified. In Step 103, this program to test the texted metal short circuit is executed in accordance with the verification result in Step 102. And in Step 104, the flow process of the present example ends.

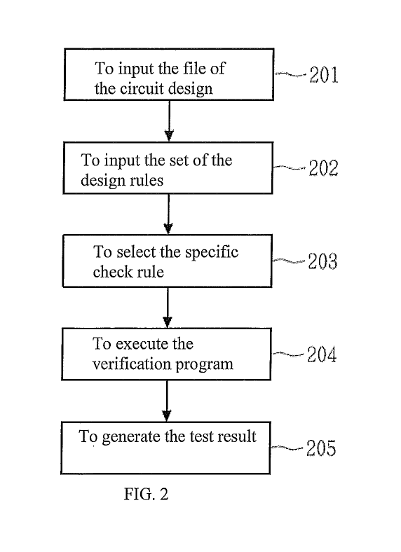

Based on an example of the present invention, shown in FIG. 2 is the detailed step of Step 102. In Step 201, the file of a circuit design is input, wherein said circuit design file comprises data of the layout pattern, and the file format of said circuit design is a generic data stream format, but the present invention is not to be limited by that. Said circuit design, for example, is an IC design. In Step 202, a set of design rules are input. In Step 203, a specific check rule or examination rule is selected based on said set of design rules. Based on an example of the present invention, said specific check rule is for testing the texted metal short circuit in said circuit design. Said specific check rule will later be applied to, for example, a design rule check program. The texted metal short circuit in said circuit design is the texted metal short circuit for power distribution, input cell or output cell in said circuit design, but the present invention is not to be limited by that. In Step 204, a verification program or authentication program is executed on said circuit based on said specific check rule. Said verification program is a design rule check program. In Step 205, a test result or short circuit path detection result is generated based on the result of execution of said verification program, wherein said test result comprises all short paths in said circuit design. Said test result is a cell short test result, or hierarchical short test result, or comprises a cell short test result and a hierarchical short test result at the same time, but the present invention is not to be limited by that. These test results comprise information of the position of the texted metal short circuit.

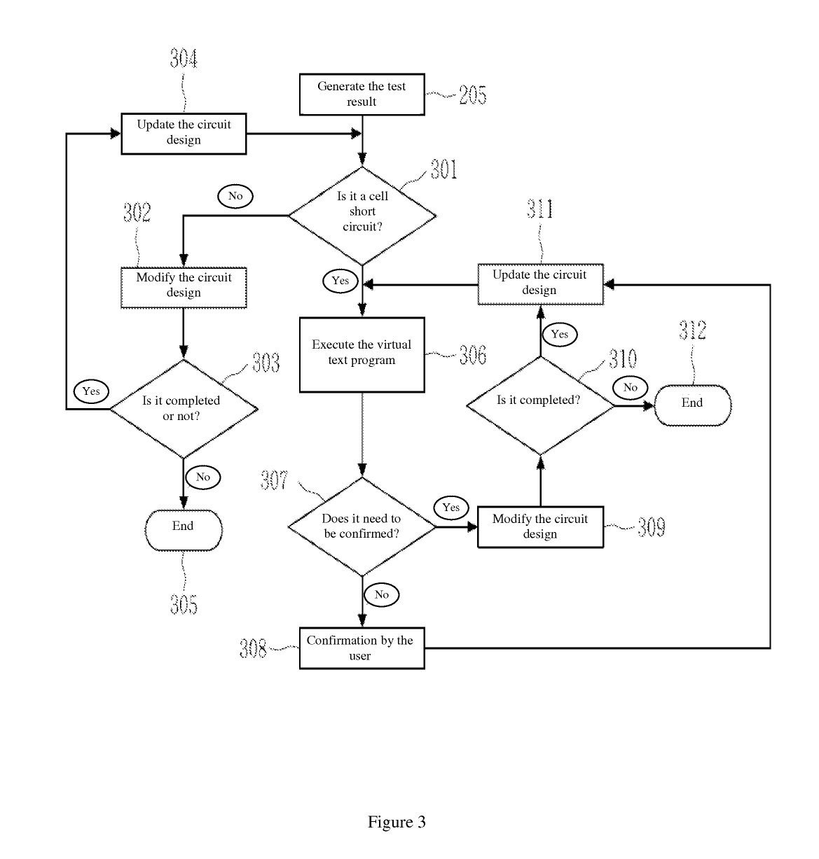

Based on an example of the present invention, Shown in FIG. 3 is the detailed step of Step 103. In Step 301, the type of the short circuit is determined based on the test result from Step 205. If said test result is a cell short circuit, then Steps 302-304 are executed to complete the test of all texted metal short circuits. If said test result is a hierarchical short circuit, then Steps 306-311 are executed to complete the testing of all texted metal short circuits. If said test result comprises a cell short circuit and a hierarchical short circuit at the same time, then it needs to execute Steps 302-304 and Step 306-311 to complete the testing of all texted metal short circuits. Based on an example of the present invention, said test result comprises a cell short circuit and a hierarchical short circuit at the same time. For a short circuit of the cell short type, the circuit design is to be modified in Step 302 in sequence in light of the cell short circuits in the test result. In Step 303, it is to determine whether the test of all cell short circuits is completed. If it is, then in Step 305, the testing of cell short circuits is ended. If it is not, then said circuit design is updated and said test result is updated in Step 304.

For a short circuit of the hierarchical short type, in Step 306, a pseudo-texted program is executed using the fuzzy algorithm in accordance with the hierarchical short circuit in the test result [sic], and a test result using the fuzzy algorithm is obtained. Said pseudo-texted program is a VDD and VSS texted program, but the present invention is not to be limited by that. In Step 307, it is determined whether there is something to be confirmed. For example, two polygons connected to each other or a two-dimensional pattern are texted differently. In this case, the user needs to confirm if the connection is correct. Therefore, if it needs to be confirmed by the user, then whether the connection is correct is to be confirmed in Step 308. After that, in Step 311, said circuit design is updated and said test result obtained using the fuzzy algorithm is updated. If the determination in Step 307 does not need to be confirmed by the user, then in Step 309, the circuit design is modified in light of the test result obtained using the fuzzy algorithm. In Step 310, whether the testing of all texted metal short circuits has been completed is determined. If it is, then in Step 312, the testing of hierarchical short circuits is ended. If it is not, then said circuit design is updated and said test result is updated in Step 311.

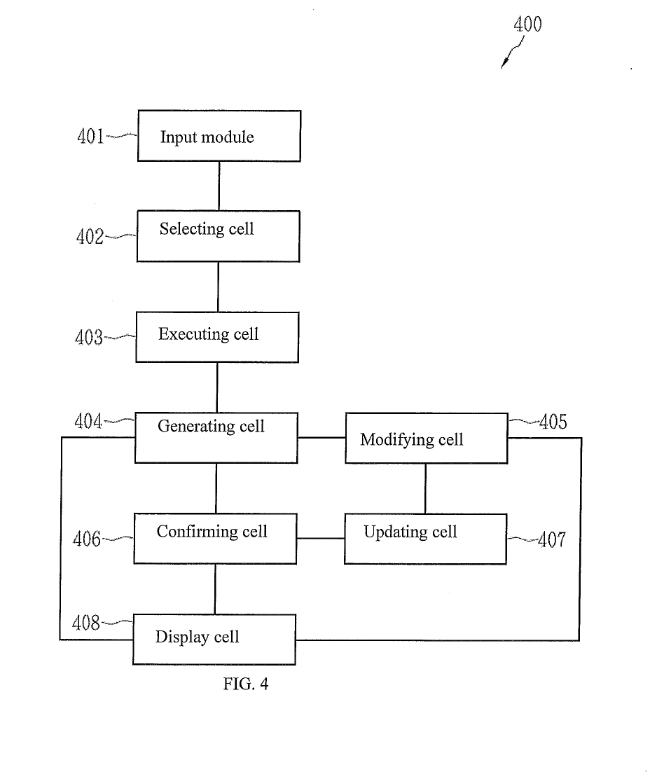

FIG. 4 is a block view showing another example of the device to test a texted metal short circuit. The device to test the texted metal short circuit 400 comprises an input module 401, a selecting cell 402, an executing cell 403, a generating cell 404, a modifying cell 405, a confirming cell 406, an updating cell 407, and a display cell 408. Said input module 401 is constructed to input a circuit design file and a set of design rules, wherein said circuit design file comprises data of the layout pattern, and the file format of said circuit design is a generic data stream format, but the present invention is not to be limited by that. Said circuit design, for example, is an IC design. Said selecting cell 402 is constructed to select a specific check rule based on said set of design rules. Said specific check rule is for testing at least one texted metal short circuit in said circuit design, but the present invention is not to be limited by that. Said at least one texted metal short circuit in said circuit design is the texted metal short circuit for power distribution, input cell, or output cell in said circuit design, but the present invention is not to be limited by that. Said executing cell 403 is constructed to execute a verification program on said circuit design based on said specific check rule and to execute a pseudo-texted program using a fuzzy algorithm based on the result of said verification program. Said verification program is a design rule check program. Said pseudo-texted program is a VDD and VSS texted program, but the present invention is not to be limited by that. Said generating cell 404 is constructed to generate a test result or a prompt status to be confirmed, based on the result of said verification program or the result of said pseudo-texted program. Said test result is a cell short test result, or a hierarchical short test result, or it comprises a cell test result and a hierarchical short test result at the same time, but the present invention is not to be limited by that. Said test result also comprises information of the position of the texted metal short circuit. Said modifying cell 405 is constructed to modify said circuit design based on said test result. Said confirming cell 406 is constructed to obtain the information of confirmation of said status to be confirmed provided by a user. Said updating cell 407 is constructed to update said test result or said status to be confirmed based on a modification result of said modifying cell. And said display cell 408 is constructed to display said test result or said status to be confirmed.

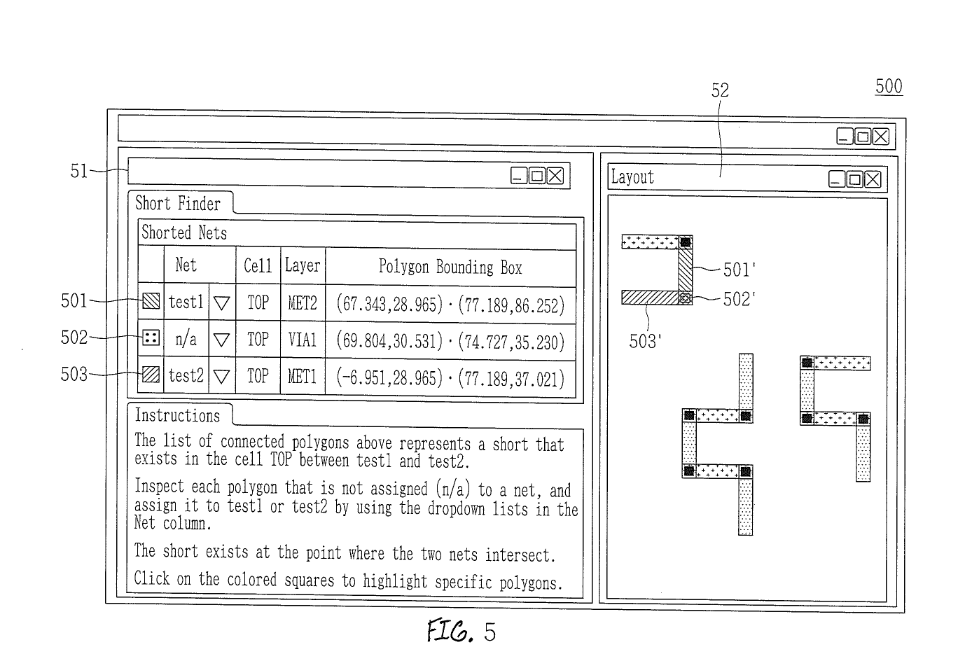

FIG. 5 shows an example of short circuit position detecting window 500. The related information of the user regarding a unit short circuit path is provided based on that unit short circuit path and partial content of a prompt status, such as short finder window 51, in the short circuit path detection result. The content of the prompt status includes, for example, shorted net information and the instruction information. The present invention, however, is not limited to this. The shorted net information includes different kinds of polygonal information, such as patterns 501, 502, and 503. Their corresponding polygons in layout window 52 are 501′, 502′, and 503′, respectively. The user can obtain, for example, the net, unit, and hierarchy to which polygon 501′ (the corresponding pattern is 501) belongs and the related coordinate information of polygon 501′ in layout window 52 from the shorted net information. Additionally, the user can obtain, for example, the fact that a short circuit is present between net test 1 and net test 2 in unit TOP from the instruction information. The user can also confirm that 503 and 503′ belong to net test 1 or net test 2 based on the prompt in the instruction information. The instruction information also reminds the user of the position where the short circuit is present. The user can click on and select pattern 501, 502, or 503. As a result, the corresponding polygon in layout window 52 will be highlighted and displayed.

An embodiment of an interactive method for detecting character labeled metal short circuit positions is characterized by including the following steps: providing a circuit design that includes the data of the layout pattern; providing a design rule group; selecting a specific examination rule based on this design rule group; executing an authentication program with respect to the circuit design based on the specific examination rule in order to obtain a first short circuit path detection result that includes all of the short circuit paths in this circuit design; and generating a first prompt status based on the first short circuit path detection result so that the user can confirm the first metal short circuit position in order to accelerate the detection of metal short circuit positions labeled with characters in this circuit design.

The method can also include a step in which a fuzzy algorithm is used to execute a pseudo character labeling program based on the first short circuit path detection result in order to obtain a second short circuit path detection result. A second prompt status can abe generated based on the second short circuit path detection result so that the user can confirm the second metal short circuit position. A status to confirm can be generated based on the second short circuit path detection result.

The method can also include a step in which a third short circuit path detection result is obtained based on the confirmation result provided by the user with respect to the status to confirm. The first short circuit path detection result, the second short circuit path detection result, and the third short circuit path detection result are unit short circuit path detection results, hierarchical short circuit path detection results, or simultaneously include unit short circuit path detection results and hierarchical short circuit path detection results.

The method can be further characterized by the fact that the authentication program is a design rule examination program; by the fact that the pseudo character labeling program is a character program used for labeling VDD and VSS; by the fact that the file format of this circuit design is a common data stream format; by the fact that the circuit design is an integrated circuit design; and by the fact that the specific examination rule is used to detect at least one character labeled metal short circuit path in this circuit design. At least one character labeled metal short circuit path in the circuit design is the character labeled metal short circuit path of the power distribution, input unit or output unit in this circuit design.

An embodiment of interactive device for detecting character labeled metal short circuit position is characterized by including an input module that is constructed to input a circuit design and a design rule group with the circuit design file including the data of the layout pattern; a selection unit that is constructed to select a specific examination rule based on the design rule group; an execution unit that is constructed to execute an authentication program with respect to the circuit design based on the specific examination rule or use a fuzzy algorithm to execute a pseudo character labeling program based on the result of the authentication program; a generation unit that is constructed to generate a short circuit path detection result based on the result of the authentication program or the result of the pseudo character labeling program; and an interaction unit that is constructed to a prompt status or a status to confirm based on the short circuit path detection result. The device can also include an update unit constructed to update the short circuit path detection result, the prompt status, or the status to confirm based on the reply information provided by the user with respect to the prompt status or the confirmation information provided by the user with respect to the status to confirm.

A display unit can be included that is constructed to display the short circuit path detection result, the prompt status, or the status to confirm. The short circuit path detection result is a unit short circuit path detection result, a hierarchical short circuit path detection result, or simultaneously includes the unit short circuit path detection result and the hierarchical short circuit path detection result.

The device can be characterized by the fact that the authentication program includes a design rule examination program; by the fact that the pseudo character labeling program is a character program used for labeling VDD and VSS; by the fact that the file format of this circuit design is a common data stream format; by the fact that the circuit design is an integrated circuit design; by the fact that the specific examination rule is used to detect at least one character labeled metal short circuit path in this circuit design; and by the fact that said at least one character labeled metal short circuit path in the circuit design is the character labeled metal short circuit path of the power distribution, input unit or output unit in this circuit design.

The technical content and technical features of the present invention have been disclosed as above, but those who are familiar with this technology, based on the instruction and disclosure of the present invention, can still make various replacements and modifications without deviating from the spirit of the present invention. Therefore, the scope of the claims of the present invention should not be restricted to what has been disclosed in the examples, but should include various replacements and modifications which do not deviate from the present invention, and are covered by the claims above.

1. A method to test at least one texted metal short circuit comprising:
inputting a circuit design file, wherein the circuit design file comprises data of a layout pattern of the circuit design;
inputting a set of design rules;
selecting a specific check rule based on the set of design rules;
executing a verification program on the circuit design based on the specific check rule so as to obtain a first test result, wherein the first test result comprises all short circuit paths in the circuit design; and
based on the first rest result, executing a pseudo-texted program using a fuzzy algorithm so as to obtain a second test result.

2. A method as described in claim 1, further comprising:
confirming a first status which is generated based on the second test result.

3. A method as described in claim 2, further comprising:
modifying the circuit design based on the first test result; and obtaining a third test result.

4. A method as described in claim 3, further comprising:
obtaining a fourth test result based on the result of confirmation of the status.

5. A method as described in claim 4, wherein the first test result, the second test result, the third test result, and the fourth test result are one or both of cell short test result and hierarchical short test results.

6. A method as described in claim 4, wherein the first test result, the second test result, the third test result, and the fourth test result comprise information of a position of the at least one texted metal short circuit.

7. A method as described in claim 1, wherein the verification program comprises execution of a design rule check program.

8. A method as described in claim 1, wherein the pseudo-texted program is a VDD and VSS texted program.

9. A method as described in claim 1, wherein the file format of the circuit design is a generic data stream format.

10. A method as described in claim 1, wherein the circuit design is an IC design.

11. A method as described in claim 1, wherein the specific check rule is for testing the at least one texted metal short circuit in the circuit design.

12. A method as described in claim 1, wherein the at least one texted metal short circuit in the circuit design is a texted metal short circuit for power distribution, input cell or output cell in the circuit design.

13. A device to test at least one texted metal short circuit comprising:
an input module, constructed to input a circuit design file and a set of design rules, wherein the circuit design file comprises data of a layout pattern;
a selecting cell, constructed to select a specific check rule based on the set of design rules;
an executing cell, constructed to execute a verification program on the circuit design based on the specific check rule, and to execute a pseudo-texted program using a fuzzy algorithm based on a result of the verification program; and
a generating cell, constructed to generate a test result or a status to be confirmed, based on the result of the verification program or a result of the pseudo-texted program.

14. A device as described in claim 13, further comprising:
a modifying cell, constructed to modify the circuit design based on the test result.

15. A device as described in claim 14, further comprising:
a confirming cell, constructed to obtain information of confirmation of the status to be confirmed provided by a user.

16. A device as described in claim 15, further comprising:
an updating cell, constructed to update the test result or the status to be confirmed based on a modification result of the modifying cell.

17. A device as described in claim 16, further comprising:
a display cell, constructed to display the test result or the status to be confirmed.

18. A device as described in claim 13, wherein the test result is one or both of a cell short test result and hierarchical short test results.

19. A device as described in claim 13, wherein the test result comprises position information of the at least one texted metal short circuit.

20. A device as described in claim 13, wherein the verification program is a design rule check program.

21. A device as described in claim 13, wherein the pseudo-texted program is a VDD and VSS texted program.

22. A device as described in claim 13, wherein the file format of the circuit design is a generic data stream format.

23. A device as described in claim 13, wherein the circuit design is an IC design.

24. A device as described in claim 13, wherein the specific check rule is for testing the at least one texted metal short circuit in the circuit design.

25. A device as described in claim 13, wherein the at least one texted metal short circuit in the circuit design is a texted metal short circuit for power distribution, input cell or output cell in the circuit design.
